(19) United States
(12) Patent Application Publication
(10) Pub. No.: US 2017/0367320 A1
(43) Pub. Date: Dec. 28, 2017

(54) HANDS FREE WILDLIFE REED CALL AND METHODS OF USE

(71) Applicant: Graham C. ALLEN, Marietta, GA (US)

(72) Inventor: Graham C. ALLEN, Marietta, GA (US)

(21) Appl. No.: 15/629,692

(22) Filed: Jun. 21, 2017

Related U.S. Application Data
(60) Provisional application No. 62/353,899, filed on Jun. 23, 2016.

(51) Int. Cl. A01M 31/00

(52) U.S. Cl. CPC A01M 31/004

(57) ABSTRACT

An audible reed assembly and an elongated tube having a first tube end and a second tube end, the first tube end connected thereto the audible reed assembly, a diaphragm bag having an opening, wherein the bag is filled with a recoil stuffing fiber, the audible reed assembly is positioned therethrough the opening with the second tube end extended therefrom, and a tie to releasably seal the opening of the diaphragm bag thereto the first tube end or the audible reed assembly, and thus functions to functions to provide a hands free and moisture free call device, sound reproduction consistency, utilization of ambient temperature air to be propelled through the reed, enabling the hunter to keep focus on the landscape, maintain one's grip on the fire arm or other hunting weaponry making it easier to spot incoming animals and maintain hands on the weapon ready to get the shot off.

### CROSS-REFERENCE TO RELATED APPLICATIONS

To the full extent permitted by law, the present United States Non-provisional Patent Application hereby claims priority to and the full benefit of United States Provisional Application entitled “WILDLIFE REED CALL IN A BAG (GRUNT BAG),” having assigned Ser. No. 62/353,899, filed on Jun. 23, 2016, incorporated herein by reference in its entirety.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

### Technical Field of the Disclosure

This disclosure relates generally to hunting accessories and, more specifically, hands free wildlife call devices.

### Description of the Related Art

Wildlife game calls are devices used to mimic animal noises to attract or drive animals to a hunter. These hunters remain hidden or camouflaged from prey, and make noise with game calls. Wildlife game callers success depends on producing a convincing enough reproduction of an animal's calls to convince the game animal to come to the hunter.

One previous approach to wildlife game call is handheld mouth-blown blow through reeds or horns for human exhale to generate or mimic animal sounds. These calls require considerable practice and the right environmental conditions to generate convincing reproduction of an animal's calls. One disadvantage of this approach is that using your hands and mouth to produce a convincing wildlife game call can take one's focus off of the landscape, making it more difficult to spot incoming animals and remove hands from weapon making it more difficult get the best shot off. Another disadvantage of this approach is that handheld and mouth-blown calls don't sound exactly the same, due to operator errors and differing environmental conditions such mouth-blown calls lack sound reproduction consistency. Another disadvantage of this approach is that handheld and mouth-blown calls require ambient temperature air to be propelled through the reed and if not during temperatures below exhale body air temperature may produce moisture beads forming on the reed.

Another previous approach to wildlife game call is electronic game calls, which play pre-recorded sounds capable of generating precise reproductions of an animal calls. One disadvantage of this approach is that electronic game calls require power supplies, such as batteries and these power supplies are subject to cycles of use limitations, malfunctions, degradation due to weather conditions, small buttons for operation with gloved hands, the requirement to take one's focus off of the landscape during operation and release of the fire arm or other hunting weaponry.

Another previous approach to wildlife game call is the rattle game call which includes hand rattles, two horns as rattles, and when rattled generate convincing reproduction of an animal's calls. One disadvantage of this approach is that rattles game calls require one or two hands for operation requiring the hunter to take one's focus off of the landscape during operation and release of the fire arm or other hunting weaponry.

Therefore, it is readily apparent there is a recognizable unmet need for hands free wildlife reed call and methods of use that is configured to address at least some aspects of the problems discussed above common to the traditional wildlife game calls, which specifically functions to provide a hands free and moisture free call device, sound reproduction consistency, utilization of ambient temperature air to be propelled through the reed, enabling the hunter to keep focus on the landscape, maintain one's grip on the fire arm or other hunting weaponry and, thus making it easier to spot incoming animals and maintain hands on the weapon ready to get the best shot off.

### SUMMARY

Briefly described, in an example embodiment, the present disclosure overcomes the above-mentioned disadvantages and meets the recognized need for a hands free wildlife reed call and methods of use, which generally includes an audible reed assembly and an elongated tube having a first tube end and a second tube end, the first tube end connected thereto the audible reed assembly, a diaphragm bag having an opening, wherein the bag is filled with a recoil stuffing fiber, the audible reed assembly is positioned therethrough the opening with the second tube end extended therefrom, and a tie to releasably seal the opening of the diaphragm bag thereto the first tube end or the audible reed assembly, and thus functions to functions to provide a hands free and moisture free call device, sound reproduction consistency, utilization of ambient temperature air to be propelled through the reed, enabling the hunter to keep focus on the landscape, maintain one's grip on the fire arm or other hunting weaponry and, thus making it easier to spot incoming animals and maintain hands on the weapon ready to get the best shot off.

According to its major aspects and broadly stated, the disclosure of the hands free wildlife reed call and methods of use that generally includes an audible reed assembly and an elongated corrugated flexible tube having a first tube end and a second tube end, the first tube end connected thereto the audible reed assembly, a diaphragm bag having an opening, wherein the bag is filled with a recoil stuffing fiber, the audible reed assembly is positioned therethrough the opening with the second tube end extended therefrom, and a tie to releasably seal the opening of the diaphragm bag thereto the first tube end or the audible reed assembly.

In an exemplary embodiment, a hands free wildlife call assembly for operator hands free movement of air to generate animal noises or grunts, includes a flexible bag formed with an interior and having an aperture therethrough said flexible bag to said interior, a recoil material, said recoil material positioned within said interior of said flexible bag, an audible reed assembly, said audible reed assembly at least partially positioned therethrough said aperture, and a tie seal, said tie seal configured to seal said aperture therearound said audible reed assembly, a sound conduit having a first conduit end and a second conduit end, said second conduit end connected thereto said audible reed assembly and said first conduit end extends therefrom said flexible bag, wherein said sound conduit is configured as flexible to direct the animal noises emanating therefrom.

In an exemplary embodiment, the method of an operator generating hands free animal noises by moving air through a wildlife call, including the steps of providing a wildlife call assembly, said wildlife call assembly having a flexible bag formed with an interior and having an aperture therethrough said flexible bag to said interior, a recoil material, said recoil material positioned within said interior of said flexible bag, an audible reed assembly, said audible reed assembly at least partially positioned therethrough said aperture, a tie seal, said tie seal configured to seal said aperture therearound said audible reed assembly, a sound conduit having a first conduit end and a second conduit end, said second conduit end connected thereto said audible reed assembly and said first conduit end extends therefrom said flexible bag, wherein said sound conduit is configured as flexible to direct the animal noises emanating therefrom and positioning said flexible bag between a stationary surface and the operator's moveable surface.

Accordingly, a feature of the wildlife reed call assembly and methods of use is the ability to ability to exhale air through the reed and tube to generate a grunt type sound or the like using ambient air held in the diaphragm bag verses moist warm human air causing moisture and ice crystals to form on the reed altering the sound produced by the reed.

Another feature of the wildlife reed call assembly and methods of use is the ability to provide hands free operation wherein the diaphragm bag may be tucked under the arm or in hunter's pant or under foot for hands free operation of the device leaving hands free to be in position on firearm or bow.

Still another feature of the wildlife reed call assembly and methods of use is its ability to provide cold weather year round use and operation due to moisture free design.

Yet another feature of the wildlife reed call assembly and methods of use is its ability to adjust the reed within the reed device to generate different sounds or tones.

Yet another feature of the wildlife reed call assembly and methods of use is its ability to interchange the reed within the reed device to generate different sounds or tones.

Yet another feature of the wildlife reed call assembly and methods of use is its ability to generate life like animal sounds or grunts.

Yet another feature of the wildlife reed call assembly and methods of use is its ability to generate a specific animal sound due to premeasured airflow based on sizing of diaphragm bag, reed, corrugated tube and the amount of recoil filler.

Yet another feature of the wildlife reed call assembly and methods of use is its ability to provide an elongated corrugated flexible tube to direct exiting sound toward an area where wildlife is located or gathered.

Yet another feature of the wildlife reed call assembly and methods of use is its ability to provide a hands free compression bag and reed positioned therein as a simplified and inexpensive wildlife reed call.

Yet another feature of the wildlife reed call assembly and methods of use is its ability to enable a hunter to maintain one's grip on the fire arm or other hunting weaponry while making a game call (hands free operation).

These and other features of the wildlife reed call assembly and methods of use will become more apparent to one skilled in the art from the prior Summary and following Brief Description of the Drawings, Detailed Description of exemplary embodiments thereof, and Claims when read in light of the accompanying Drawings or Figures.

### BRIEF DESCRIPTION OF THE DRAWINGS

The present the wildlife reed call assembly and methods of use will be better understood by reading the Detailed Description of the Preferred and Selected Alternate Embodiments with reference to the accompanying drawing Figures, in which like reference numerals denote similar structure and refer to like elements throughout, and in which:

FIG. 1 is a perspective front view of an exemplary embodiment of the wildlife reed call assembly, shown assembled;

FIG. 2 is a perspective side view of an exemplary embodiment of the wildlife reed call assembly, shown unassembled;

FIG. 3 is an exploded view of an exemplary embodiment of the wildlife reed call assembly, shown assembled;

FIG. 4 is a use view of an exemplary embodiment of the wildlife reed call assembly, shown positioned between torso and arm for hands free operation;

FIG. 5 is a use view of an exemplary embodiment of the wildlife reed call assembly, shown positioned under the foot for hands free operation;

FIG. 6 is a use view of an exemplary embodiment of the wildlife reed call assembly, shown positioned between abdomen and waistline of pant for hands free operation; and

FIG. 7 is a flow diagram of a method of use of an exemplary embodiment of the wildlife reed call assembly for hands free operation.

### DETAILED DESCRIPTION

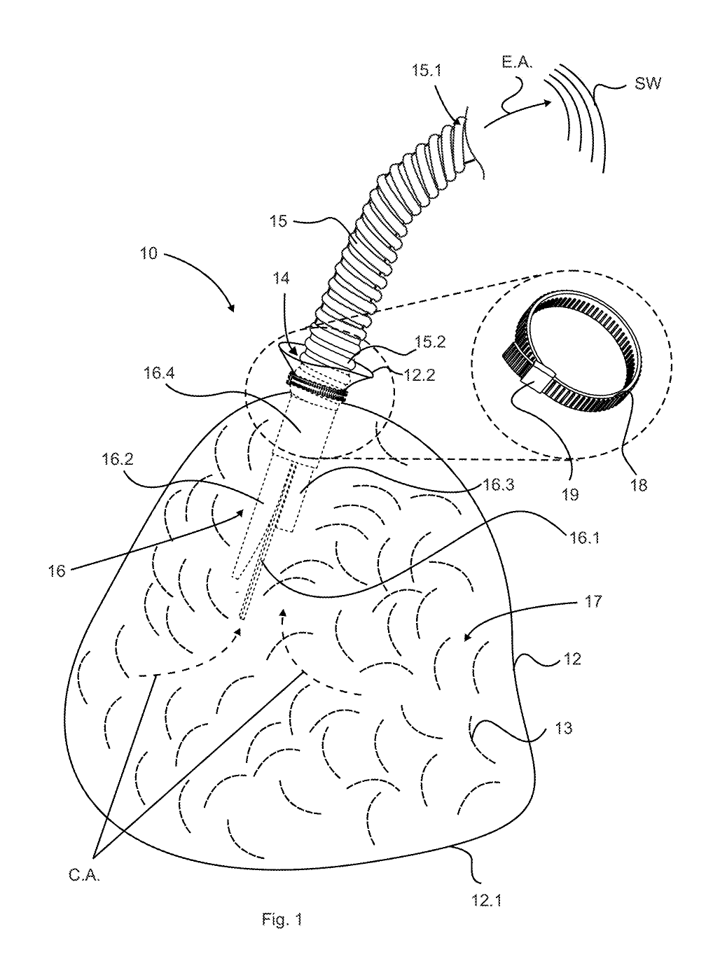

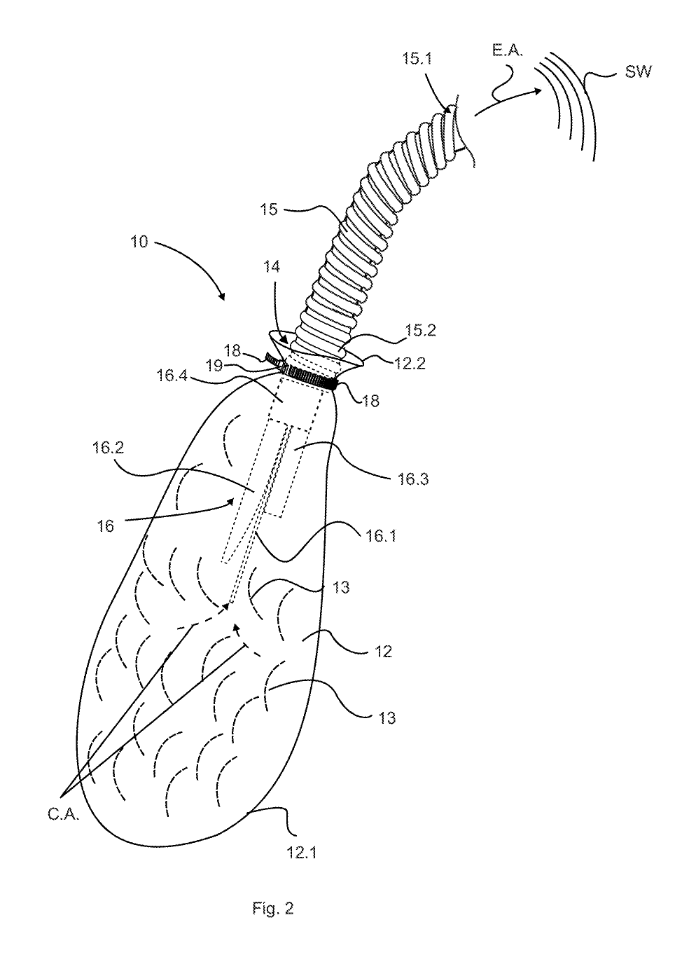

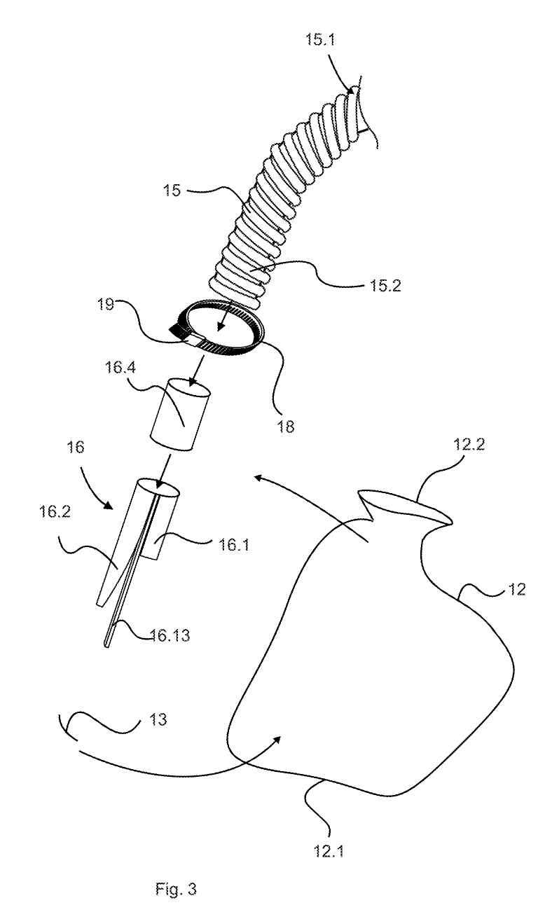

In describing the exemplary embodiments of the present disclosure, as illustrated in FIGS. 1-7, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to the FIGS. 1, 2, and 3 there is illustrated wildlife reed call assembly 10 preferably configured as a multi-piece assembled wildlife or game call, device or the like having a collapsible flexible bag or other air capture mechanism, such as diaphragm bag 12 having first end 12.1 and a second end 12.2 with an open end or hole, such as aperture 14 and an inside of space within diaphragm bag 12, such as interior 17. It is contemplated herein that diaphragm bag 12 may be flexible and collapsible to pull air in and push air out of diaphragm bag 12. Moreover, interior 17 of diaphragm bag 12 may be filled with recoil filler material or fiber, such as recoil material 13, which may be nylon stuffing, to enable compression during exhale of air from interior 17 via aperture 14 and expansion force against diaphragm bag 12 during inhale of air from interior 17 via aperture 14. It is further contemplated herein that diaphragm bag 12 may have approximate dimensions of five and a half (5½) inches wide by five and a half (5½) inches in height; however, other dimensions are contemplated herein.

It is contemplated herein that collapsible bag, such as diaphragm bag 12 may preferably be constructed of plastic, rubber, or flexible composite materials that are available in a variety of natural and synthetic fiber, composites, laminated composite material, cast materials, polymers as these materials offers a variety of forms, shapes, strengths, and weights. It is contemplated herein that other suitable materials may be utilized or the like, whether formed of multiple layers with different materials, or the like, may be utilized, provided such material has sufficient strength, flexibility, collapsibility, bendable, formable, durability, chemical resistance, offers long service life, pH tolerance, small footprint, light weight, and/or durable as would meet the purpose described herein.

It is further contemplated herein that interior 17 of diaphragm bag 12 may be filled with fibrous material, such as recoil material 13, which may be nylon, Styrofoam or other like material or recoil stuffing materials may be utilized or the like, whether formed of strands, three dimensional curved forms to create air pockets, or the like, may be utilized, provided such material has sufficient recoil strength, air holding capacity, durability, offers long service life, pH tolerance, light weight, and/or durable as would meet the purpose described herein.

Furthermore, wildlife reed call assembly 10 preferably configured as a multi-piece assembled wildlife or game call, device or the like further includes a vibrational sound generator, such as audible reed assembly 16 having reed 16.1, a reed mount, such as first reed mount 16.2, second reed mount 16.3, and reed collar 16.4. Preferably, reed 16.1 may be positioned between first reed mount 16.2 and second reed mount 16.3 and positioned or friction fit therein reed collar 16.4 or otherwise configured to hold reed 16.1 between first reed mount 16.2 and second reed mount 16.3.

It is contemplated herein that audible reed assembly 16 may be configured in a number of sizes and lengths and configurations to generate life like animal sounds or grunts.

In use, audible reed assembly 16 may be positioned through or partially positioned therethrough aperture 14 of diaphragm bag 12 to a position interior 17 thereof diaphragm bag 12, where air or compressible air CA from within interior 17 of diaphragm bag 12 may be pushed (exhale) therethrough audible reed assembly 16 resulting in an audible vibration noise emanating therefrom audible reed assembly 16. Moreover, recoil material 13 includes expansion properties thereon interior 17 of diaphragm bag 12 where air or compressible air CA from outside of diaphragm bag 12 may be pulled (inhale) therethrough audible reed assembly 16 resulting in an audible vibration noise emanating therefrom audible reed assembly 16. Alternatively, air or compressible air CA from outside of diaphragm bag 12 may be pulled therein interior 17 of diaphragm bag 12 passing therethrough audible reed assembly 16 to expand of diaphragm bag 12.

It is contemplated herein that pitch of the audible vibration noise may be altered by changing reed 16.1 length, first reed mount 16.2 and second reed mount 16.3 length or position relative to reed 16.1 and the like and by manual modifications of the effective length of the vibrating column of air.

Still furthermore, wildlife reed call assembly 10 may include a tie seal or cinch, such as zip tie 18 utilized to seal or cinch second bag end, having lip 12.2 of aperture 14 thereto or therearound audible reed assembly 16 or more specifically thereto reed collar 16.4 to seal the junction between aperture 14 and audible reed assembly 16.

Moreover, wildlife reed call assembly 10 may include a sound conduit, such as elongated tube 15 having first tube end 15.1 and second tube end 15.2. Preferably, second tube end 15.2 may be releasably affixed, connects or connected thereto audible reed assembly 16 or more specifically thereto reed collar 16.4 whether second tube end 15.2 may be positioned within interior 17 of diaphragm bag 12 or whether second tube end 15.2 extends therefrom lip 12.2 of aperture 14. It is contemplated herein that elongated tube 15 may be flexible and/or corrugated to enable directional output of direct exhaust air EA and audible vibration noise, such as sound waves SW emanating therefrom wildlife reed call assembly 10 and/or muffle or sound modification of audible vibration noise or exhaust air EA and audible vibration noise, such as sound waves SW emanating therefrom wildlife reed call assembly 10.

It is further contemplated herein that audible reed assembly 16 connected thereto second tube end 15.2 may be positioned therethrough aperture 14 and into interior 17 of diaphragm bag 12 with first tube end 15.1 extended therefrom diaphragm bag 12 to direct exhaust air EA and audible vibration noise, such as sound waves SW emanating therefrom wildlife reed call assembly 10. Furthermore, a tie to seal or cinch, such as zip tie 18 may be utilized to seal or cinch second bag end, having lip 12.2 of aperture 14 thereto audible reed assembly 16 or more specifically thereto second tube end 15.2 to seal the junction between aperture 14 and second tube end 15.2, and a tie to releasably seal the opening of the diaphragm bag thereto second tube end 15.2.

It is still further contemplated herein that as elongated tube 15 may have approximate dimensions of eight (8) inches in length and five-eighths (⅝) inches in diameter; however, other dimensions are included herein.

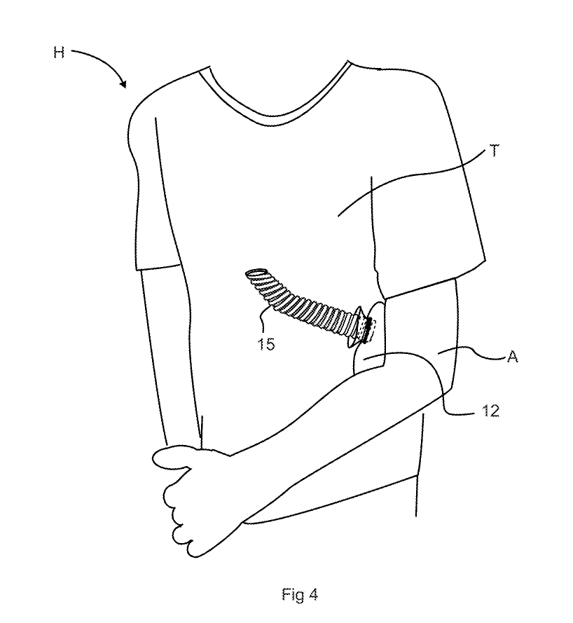

Referring now to the FIG. 4 there is illustrated wildlife reed call assembly 10 shown in use to provide hands free operation of wildlife reed call assembly 10 to generate life like animal sounds, mimic animal noises or grunts to attract or drive animals to a hunter. In use, an operator or hunter H may be positioned or tuck diaphragm bag 12 between torso T and arm A, whereby movement or pivot of arm A collapses interior 17 of diaphragm bag 12 to push air or compressible air CA from within interior 17 of diaphragm bag 12 therethrough audible reed assembly 16 resulting in an audible vibration noise emanating therefrom audible reed assembly 16. Moreover, release of arm A enables recoil material 13 expansion properties thereon interior 17 of diaphragm bag 12 where air or compressible air CA from outside of diaphragm bag 12 may be pulled therethrough audible reed assembly 16 resulting in an audible vibration noise emanating therefrom audible reed assembly 16; thus providing hands free operation of wildlife reed call assembly 10. Alternatively, air or compressible air CA from outside of diaphragm bag 12 may be pulled therein interior 17 of diaphragm bag 12 passing therethrough audible reed assembly 16.

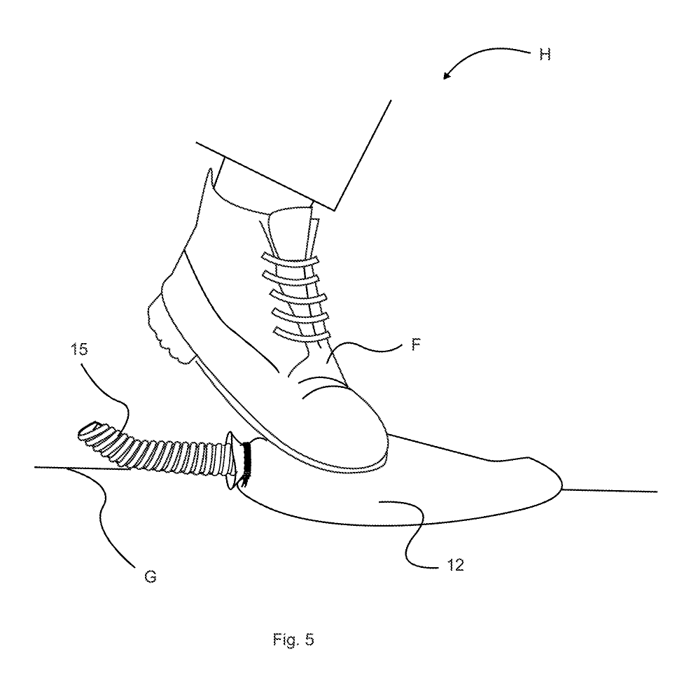

FIG. 5 there is illustrated wildlife reed call assembly 10 shown in use to provide hands free operation of wildlife reed call assembly 10 to generate life like animal sounds, mimic animal noises or grunts to attract or drive animals to a hunter. In use, an operator or hunter H may position or tuck diaphragm bag 12 under their foot F between any surface, such as ground G and foot F, whereby movement or pivot of foot F collapses interior 17 of diaphragm bag 12 to push air or compressible air CA from within interior 17 of diaphragm bag 12 therethrough audible reed assembly 16 resulting in an audible vibration noise emanating therefrom audible reed assembly 16. Moreover, release of foot F enables recoil material 13 expansion properties thereon interior 17 of diaphragm bag 12 where air or compressible air CA from outside of diaphragm bag 12 may be pulled therethrough audible reed assembly 16 resulting in an audible vibration noise emanating therefrom audible reed assembly 16; thus providing hands free operation of wildlife reed call assembly 10. Alternatively, air or compressible air CA from outside of diaphragm bag 12 may be pulled therein interior 17 of diaphragm bag 12 passing therethrough audible reed assembly 16.

It is contemplated herein that diaphragm bag 12 may be placed against other surfaces and a body part may be utilized to push and pull air or compressible air CA therethrough audible reed assembly 16 resulting in an audible vibration noise (mimic animal noises or grunts to attract or drive animals to a hunter) emanating therefrom audible reed assembly 16.

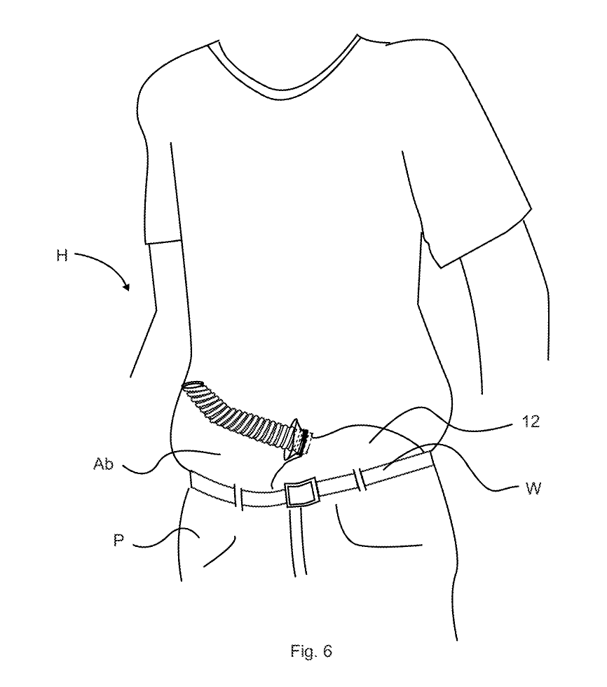

Referring now to the FIG. 6 there is illustrated wildlife reed call assembly 10 shown in use to provide hands free operation of wildlife reed call assembly 10 to generate life like animal sounds, mimic animal noises or grunts to attract or drive animals to a hunter. In use, an operator or hunter H may position or tuck diaphragm bag 12 between abdomen Ab and operator's waistline W of pant P, whereby movement or pivot of abdomen Ab collapses interior 17 of diaphragm bag 12 to push air or compressible air CA from within interior 17 of diaphragm bag 12 therethrough audible reed assembly 16 resulting in an audible vibration noise emanating therefrom audible reed assembly 16. Moreover, release of abdomen Ab enables recoil material 13 expansion properties thereon interior 17 of diaphragm bag 12 where air or compressible air CA from outside of diaphragm bag 12 may be pulled therethrough audible reed assembly 16 resulting in an audible vibration noise emanating therefrom audible reed assembly 16; thus providing hands free operation of wildlife reed call assembly 10. Alternatively, air or compressible air CA from outside of diaphragm bag 12 may be pulled therein interior 17 of diaphragm bag 12 passing therethrough audible reed assembly 16.

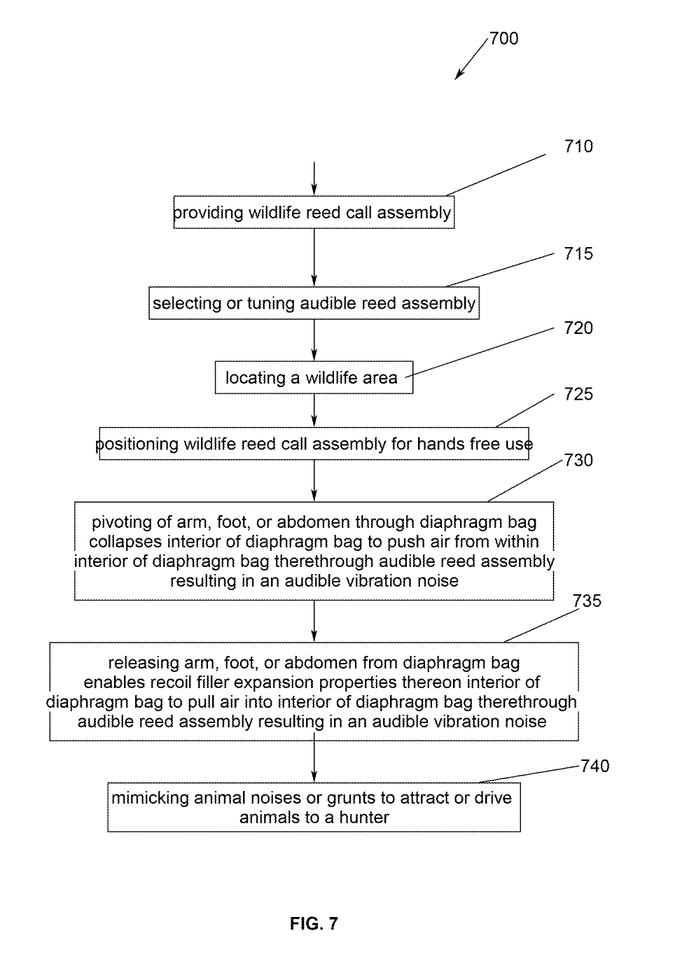

Referring now to FIG. 7, there is illustrated a flow diagram 700 of a method of generating animal noises utilizing wildlife reed call assembly 10. In block or step 710, providing wildlife reed call assembly 10 as set forth in FIGS. 1-6. In block or step 715 selecting or tuning audible reed assembly 16 of wildlife reed call assembly 10 to mimic or generate animal noises to 2 5 attract or drive animals to a hunter. In block or step 720 locating a wildlife area to attract or drive animals to an operator, such as a hunter. In block or step 725, positioning wildlife reed call assembly 10 for use in an operators hands or in a hands free position, such as operator or hunter H may position or tuck diaphragm bag 12 between torso T and arm A, operator or hunter H may position or tuck diaphragm bag 12 under their foot F between any surface, such as ground G and foot F, or operator or hunter H may position or tuck diaphragm bag 12 between abdomen Ab and operator's waistline W of pant P. It is contemplated herein that diaphragm bag 12 may be positioned between a firm or stationary surface, such as torso T, ground G, operator's waistline W of pant P or like stationary surface and an operator's moveable surface or pivoting body part, such as arm A, foot F, and abdomen Ab or like moveable operator surface. In block or step 730, movement or pivoting of arm A, foot F, or abdomen Ab through diaphragm bag 12 collapses interior 17 of diaphragm bag 12 to push air or compressible air CA from within interior 17 of diaphragm bag 12 therethrough audible reed assembly 16 resulting in an audible vibration noise emanating therefrom audible reed assembly 16. In block or step 735, releasing of arm A, foot F, or abdomen Ab from diaphragm bag 12 enables recoil material 13 expansion properties thereon interior 17 of diaphragm bag 12 where air or compressible air CA from outside of diaphragm bag 12 may be pulled therethrough audible reed assembly 16 resulting in an audible vibration noise emanating therefrom audible reed assembly 16 or alternatively, pulling air or compressible air CA from outside of diaphragm bag 12 therein interior 17 of diaphragm bag 12. In block or step 740, mimicking or generating animal noises or grunts to attract or drive animals to a hunter.

The foregoing description and drawings comprise illustrative embodiments of the present disclosure. Having thus described exemplary embodiments, it should be noted by those ordinarily skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments of the disclosure will come to mind to one ordinarily skilled in the art to which this disclosure pertains having the benefit of the teachings presented in the foregoing descriptions and the associated drawings. Although specific terms may be employed herein, they are used in a generic and descriptive sense only and not for purposes of limitation. Moreover, the present disclosure has been described in detail, it should be understood that various changes, substitutions and alterations can be made thereto without departing from the spirit and scope of the disclosure as defined by the appended claims. Accordingly, the present disclosure is not limited to the specific embodiments illustrated herein, but is limited only by the following claims.

What is claimed:

1. A wildlife call assembly for operator hands free movement of air to generate animal noises or grunts, the call assembly comprising:
a flexible bag formed with an interior and having an aperture therethrough said flexible bag to said interior;
a recoil material, said recoil material positioned within said interior of said flexible bag;
an audible reed assembly, said audible reed assembly at least partially positioned therethrough said aperture; and
a tie seal, said tie seal configured to seal said aperture therearound said audible reed assembly.

2. The call assembly of claim 1, further comprises a sound conduit having a first conduit end and a second conduit end, said second conduit end connected thereto said audible reed assembly and said first conduit end extends therefrom said flexible bag.

3. The call assembly of claim 2, wherein said sound conduit is configured as flexible to direct the animal noises emanating therefrom.

4. The call assembly of claim 2, wherein said audible reed assembly further comprises a reed, at least one reed mount, and a reed collar, wherein said tie seal configured to seal said aperture therearound said reed collar.

5. The call assembly of claim 4, wherein said second conduit end connects thereto said reed collar.

6. The call assembly of claim 3, wherein said flexible bag is positioned between a torso and an arm of the operator, wherein pivot of said arm collapses said flexible bag to push the air therethrough said audible reed assembly to generate the animal noises.

7. The call assembly of claim 6, wherein release of said arm from said flexible bag enables said recoil material to expand and pull the air therein said flexible bag.

8. The call assembly of claim 3, wherein said flexible bag is positioned between a foot of the operator and a surface, wherein pivot of said foot collapses said flexible bag to push the air therethrough said audible reed assembly to generate the animal noises.

9. The call assembly of claim 8, wherein release of said foot from said flexible bag enables said recoil material to expand and pull the air therein said flexible bag.

10. The call assembly of claim 3, wherein said flexible bag is positioned between an abdomen and a waistline of a pant of the operator, wherein pivot of said abdomen collapses said flexible bag to push the air therethrough said audible reed assembly to generate the animal noises.

11. The call assembly of claim 10, wherein release of said abdomen from said flexible bag enables said recoil material to expand and pull the air therein said flexible bag.

12. A method of an operator generating hands free animal noises by moving air through a wildlife call, said method comprising the steps of:
providing a wildlife call assembly, said wildlife call assembly having a flexible bag formed with an interior and having an aperture therethrough said flexible bag to said interior, a recoil material, said recoil material positioned within said interior of said flexible bag, an audible reed assembly, said audible reed assembly at least partially positioned therethrough said aperture, a tie seal, said tie seal configured to seal said aperture therearound said audible reed assembly, a sound conduit having a first conduit end and a second conduit end, said second conduit end connected thereto said audible reed assembly and said first conduit end extends therefrom said flexible bag, wherein said sound conduit is configured as flexible to direct the animal noises emanating therefrom; and
positioning said flexible bag between a stationary surface and a moveable surface of the operator.

13. The method of claim 12, wherein said moveable surface further includes a foot of the operator.

14. The method of claim 13, pivoting said foot collapses said flexible bag to push the air therethrough said audible reed assembly to generate the animal noises.

15. The method of claim 13, releasing said foot from said flexible bag enables said recoil material to expand and pull the air therein said flexible bag and said stationary surface further includes a ground.

16. The method of claim 12, wherein said moveable surface further includes an arm of the operator and said stationary surface further includes a torso of the operator.

17. The method of claim 16, pivoting said arm collapses said flexible bag to push the air therethrough said audible reed assembly to generate the animal noises.

18. The method of claim 17, releasing said arm from said flexible bag enables said recoil material to expand and pull the air therein said flexible bag.

19. The method of claim 12, wherein said moveable surface further includes an abdomen of the operator and said stationary surface further includes a waistline of a pant of the operator.

20. The method of claim 19, pivoting said abdomen collapses said flexible bag to push the air therethrough said audible reed assembly to generate the animal noises.

21. The method of claim 20, releasing said abdomen from said flexible bag enables said recoil material to expand and pull the air therein said flexible bag.

22. The method of claim 12, generating the animal noises to attract the animal to the operator.
